(19) United States
(12) Patent Application Publication
(10) Pub. No.: US 2022/0145064 A1
(43) Pub. Date: May 12, 2022

(54) A GEL AND CUSHIONING MATERIAL BASED ON THERMOPLASTIC ELASTOMERS AND METHOD OF MAKING THEREOF

(71) Applicant: Comfort Grid Technologies Private Limited, Mumbai, Mumbai City, Maharashtra (IN)

(72) Inventors: Priyanka Salot, Mumbai, Maharashtra (IN); Vijai S. Tripathi, Mumbai, Maharashtra (IN)

(21) Appl. No.: 17/310,889

(22) PCT Filed: Jan. 15, 2020
(86) PCT No.: PCT/IN2020/050043

§ 371 Date: Aug. 27, 2021

(30) Foreign Application Priority Data
Jan. 16, 2019 (IN) 201921001889

(51) Int. Cl. C08L 53/02; C08L 23/12; C08L 23/14; C08K 3/26; C08K 3/36; C08K 3/34; C08K 5/23; B29B 9/12; B29C 45/00; B29C 48/04

(52) U.S. Cl. CPC C08L 53/02; C08L 23/12; C08L 23/14; C08K 3/26; C08K 3/36; C08K 3/346; B29K 2025/08; B29B 9/12; B29C 45/0001; B29C 48/04; C08K 2003/265; B29C 2045/0091; C08K 5/23

(57) ABSTRACT

A gel material made of thermoplastic elastomers. The thermoplastic elastomers content in the gel material is very less. Even after the reduction of thermoplastic elastomers, the gel material has superior properties. The gel material of the disclosure is cost effective and has good strength. The present disclosure also relates to a cushioning material made of gel of thermoplastic elastomers. Furthermore, the present disclosure also relates to a process for making the gel and the cushioning material.

### FIELD OF INVENTION

The present disclosure relates to a field of thermoplastic elastomers (TPE). More specifically, the present disclosure relates to a gel made of thermoplastic elastomers. More specifically, the present disclosure relates to a cushioning material made of gel of thermoplastic elastomers. Further, the present disclosure also relates to a process for making the gel and the cushioning material.

### BACKGROUND

Historically, the mattress industry or the cushioning industry (sofa, chairs etc.) are dominated by foam, cotton wool wadding, metallic springs, polyurethane foams and latex foams etc. However, in last decade or so thermoplastic elastomeric materials and silicon are slowly but surely entering medical field. This is because TPE compares favorably low cost and can be recycled easily, thus environment friendly. Since, there has not been any significant development or invention into this industry. The present disclosure provides better solution.

Fluffy, solid, strong elastic gels exhibiting resistance to elastic deformation, capable of shape-memory recovery, being dimensionally stable and having a density in the range 0.6-0.99 were discovered around two decades back with applications into medical field. These substances are designated as thermoplastic elastomers and combination of properties of thermoplastics in that these can be brought into molten state and shaped and again shaped article can be brought into molten state by heating yet retain rubber like elastic properties.

References are available where the thermoplastic elastomers are used in the gels for cushioning material however, the specific gels made up of specific thermoplastic elastomers as disclosed in the present invention is not disclosed in any of the references.

Previously reported methods and recipes for fabrication of thermoplastic elastomer-based gels as cushioning material were complicated and contained many ingredients, yet desired results were not obtained. The recipe used in present disclosure does not contain as many ingredients. Blending ingredients by hot melting process as suggested in some references is quite risky, as melting point of mix specially after addition of filler becomes quite high often crossing flash point of plasticizing oil. Whole mixing and blending in present case are done at 70° C., much below the flash point of oil. Bleeding of oil, even after addition of expensive non-bleeding agents significantly in previous methods. Present composition leads to non-bleeding products. This became possible after addition of Polypropylene (PP) and azodicarbonamide (ADC) to the recipe. Bleeding of oil remains a perennial problem with any of reported recipes. To obtain required strength and stiffness often more proportion of TPE is used in the formulation, which is not desirable, cost wise.

The presently disclosed recipe/composition and process to overcome the problem of the prior art and results in a better product in terms of good strength and stiffness by addition of polypropylene (PP) and azodicarbonamide (ADC) without increasing thermoplastic elastomer (TPE) content.

The disclosed gel in the present invention is of low cost as compared to the conventionally available gels, silicon-based gel and other cushioning material like latex and memory foam. The disclosed gel has better physical and pressure relieving properties compared to traditional cushioning material like cotton, foam, spring etc. The disclosed gel has better tensile strength, elongation and compression set (evaluation of sagging over time) than any other traditional cushioning material like Memory foam, latex and foam.

The present invention also discloses a process of making gel based on thermoplastic elastomers. The present invention also relates to a design of the mattress that helps in distributing weight.

The biggest issue that the present disclosure or the gel material addresses is increase in comfort and pressure relief in cushioning materials. The present disclosure materials do not and sag over time which is major drawback of the existing materials. Thus, the present disclosure as compared to the existing materials show improvement in longevity and sagging property.

### DESCRIPTION OF THE DRAWINGS

FIG. 1—Shows a color image of cushioning element with homogeneously distributed hollow columns.

FIG. 2—Shows a 2 D drawing of above structure showing partition walls for 25/25 mm. hollow columns.

FIG. 3—Shows a 3 D drawing of a small section of cushion.

FIG. 4a-4f—Illustrates an assembly with the developed elastomeric gel to replace foam/spring/latex mattresses.

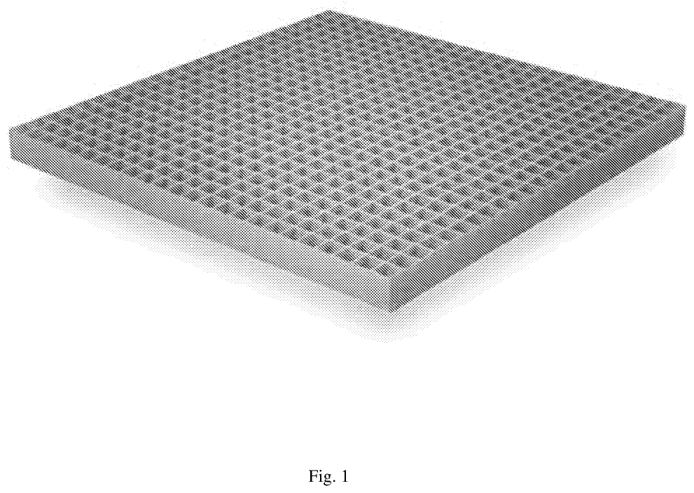

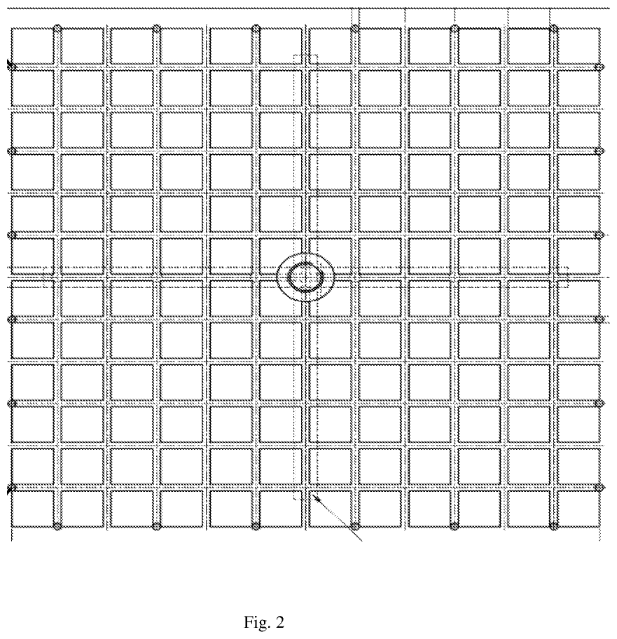

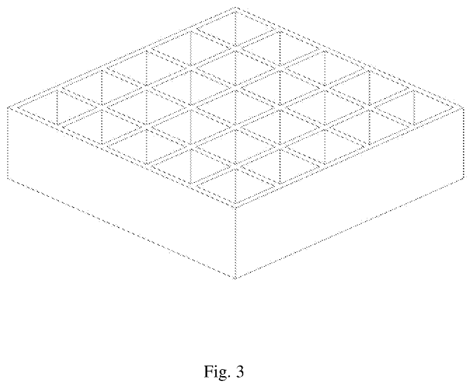

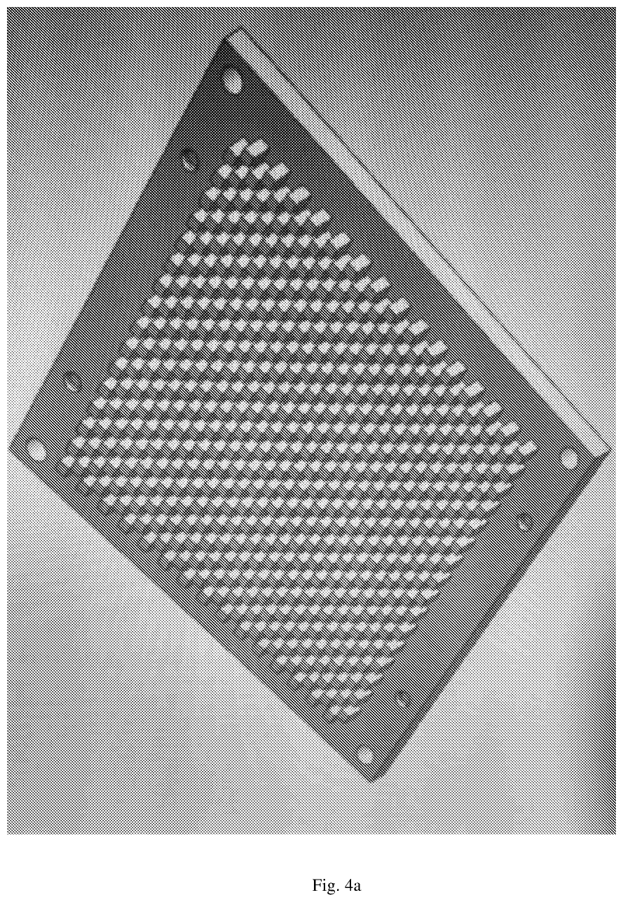

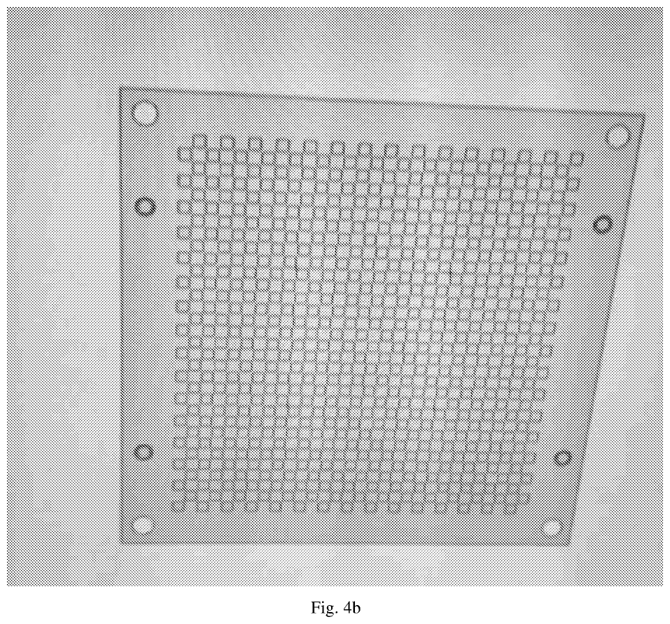

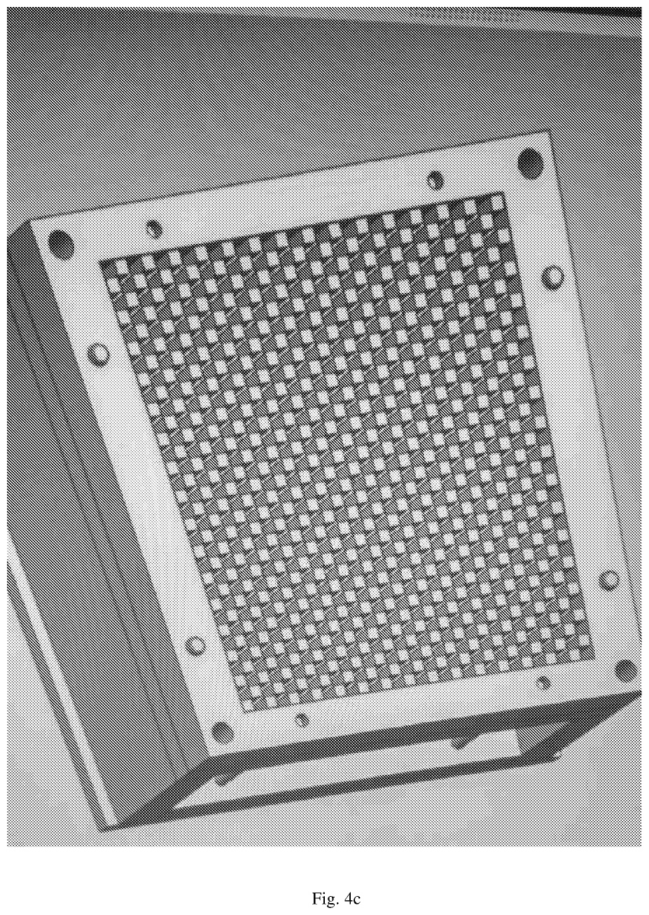

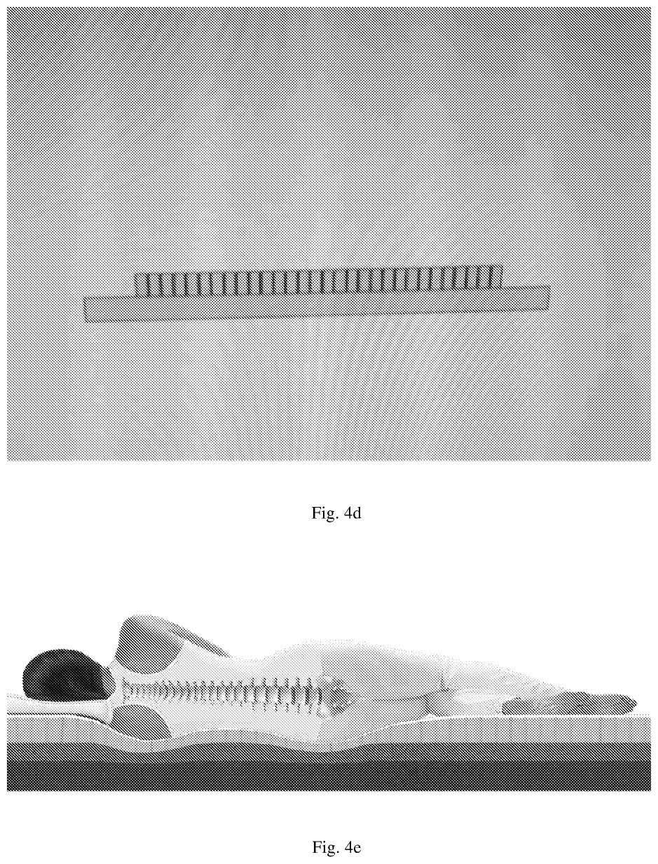

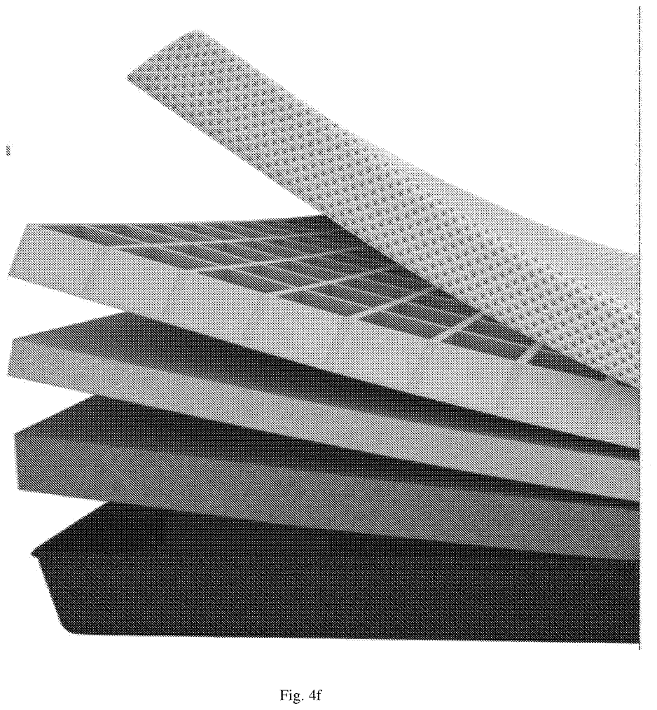

### DETAILED DESCRIPTION

While the disclosure is susceptible to various modifications and alternative forms, specific aspect thereof has been shown by way of example and will be described in detail below. It should be understood, however that it is not intended to limit the invention to the particular forms disclosed, but on the contrary, the invention is to cover all modifications, equivalents, and alternative falling within the spirit and the scope of the invention.

The Applicants would like to mention that the examples are mentioned to show only those specific details that are pertinent to understanding the aspects of the present disclosure so as not to obscure the disclosure with details that will be readily apparent to those of ordinary skill in the art having benefit of the description herein.

The terms “comprises”, “comprising”, or any other variations thereof, are intended to cover a non-exclusive inclusion, such that a method that comprises a list of components does not include only those components but may include other components not expressly listed or inherent to such process. In other words, one or more elements in a method proceeded by “comprises . . . a” does not, without more constraints, preclude the existence of other elements or additional elements in the method.

Accordingly, the present disclosure provides a gel made of thermoplastic elastomers and a cushioning material made of gel of thermoplastic elastomers. Further, the present disclosure provides a process for making the gel and the cushioning material. The thermoplastic elastomers content in the gel material is very less. Even after the reduction of thermoplastic elastomers, the gel material has superior properties. The gel material of the disclosure has good strength, stiffness and is cost effective.

In one embodiment of the present disclosure, a gel material comprising thermoplastic elastomer 15-35 wt %, mineral oil 65-85 wt %, polypropylene 1-10% and azodicarbonamide 0.5-4%.

In another embodiment of the disclosure, the thermoplastic elastomer is A-B-A type thermoplastic elastomer.

In yet another embodiment of the disclosure the thermoplastic elastomer is A-B-A type wherein A represents a crystalline polymer such as alkenylarene polymer and B represents elastomeric polymer such as polyolefins.

In yet another embodiment of the disclosure, the alkenylarene polymer is polystyrene.

In yet another embodiment of the disclosure the thermoplastic elastomer is styrene-[ethylene-(ethylene-propylene)]-styrene block copolymer.

In yet another embodiment of the disclosure, the polyolefins is polyethylene, polypropylene or polybutylene or combination thereof.

In yet another embodiment of the disclosure, the polypropylene is a homopolymer polypropylene and/or copolymer propylene.

In yet another embodiment of the disclosure, the gel material additionally comprises filler in the range of 1-10 wt % and antioxidant in the range of 0.05-0.5 wt %.

In yet another embodiment of the disclosure, the fillers are selected from precipitated silica, china clay and/or calcium carbonate, preferably the fillers are selected from clay, calcium carbonate (CaCO₃) or silica and more preferably the filler is CaCO₃.

In yet another embodiment of the disclosure, the gel material is a cushioning material.

In another embodiment of the disclosure, a method of producing the thermoplastic elastomer-based gel material as claimed in claim 1 comprising steps of: mixing ingredients (a) 65% to 85% of mineral oil, (b) 15% to 35% of thermoplastic elastomer; and (c) fillers, azodicarbonamide, ADC and antioxidants in a mixer to produce a powder, pelletizing the powder in an extruder at a temperature of 120-160° C., to produce pellets, and injection molding the pellets at a temperature in the range of between 120-190° C. to produce the thermoplastic elastomer-based gel material.

In yet another embodiment of the disclosure, the step of mixing is done in a sigma/ribbon mixer by pouring mineral oil into a heated chamber of sigma/ribbon mixer; adding thermoplastic elastomer in the oil and mixing till absorption of the oil into the elastomer and adding fillers, azodicarbonamide, ADC and antioxidants. Heating the chamber increases oil absorption which is critical for producing softer and lower than 0 Shore A articles and mixing elastomer first makes a more homogenous mixture than mixing fillers, polypropylene first

In another embodiment of the disclosure, a cushioning material comprising the thermoplastic elastomer-based gel material of the invention.

In yet another embodiment of the disclosure, the cushioning material has a buckling mold structure having homogeneously distributed hollow columns.

In yet another embodiment of the disclosure, the buckling mold structure has a male component having multiple designs of core, cavity or complimentary component of mold design.

In another embodiment of the disclosure, the elastomer-based gel material is used in a mattress, bed mat, sofa, chairs, baby head rest, knee pads, ankle pads, heel pads, pressure and pain relief applications etc.

Thermoplastic elastomer in the present disclosure is sourced from various manufactures such as SEPTON manufactured by Kuraray Corporation Japan and Aparprene by APAR Industries Ltd (India) is used in the present invention. In most of Septon grades the end groups are styrene while the middle portion of tri block copolymer may be hydrogenated poly isoprene, poly butadiene or poly isoprene/butadiene. Polystyrene contents in these thermoplastic elastomers may vary from 10 to 70%. A range of molecular weights and physical properties are available in different grades of Septons.

Mineral oil is selected from but not limited to pearl 70, pearl 85, pearl 250 and pearl 300 from Apar Industries, savanol 10, savanol 15 and savanol 20 oils from Savita Oil Technologies, oils form Gandhar Oil Refineries Ltd. Preferably, the mineral oil is selected such that the oil has lower kinetic viscosity. More preferably the mineral oil is selected from white mineral oils.

Fillers are selected from but not limited to precipitated silica, china clay and/or calcium carbonate. Preferably the fillers are selected from clay, calcium carbonate (CaCO₃) or silica. More preferably CaCO₃ which is cost effective and gives aesthetically and better properties products.

Antioxidant is selected from but not limited to Irganox provided by BASF. Preferably two Antioxidants are involved namely, primary and secondary antioxidant. The primary antioxidant is Irganox 1010 and the secondary antioxidant is Irgafos 168.

Polypropylene can be homopolymer polypropylene and/or copolymer propylene. More preferably impact polypropylene is used in the presently disclosed thermoplastic elastomer based gel for cushioning material. Further, PP with medium to high MFI impact (such as 22 to 35) gives better combination of tensile strength and elongation and effective processing.

In the present thermoplastic elastomer gel composition, there is no need of addition of anti-bleeding agent when the disclosed PP in the range of 1% to 10% is a part of gel recipe/composition. Hence, the problem of oil-bleed is also overcome in the desired product. Polypropylene also help deliver better results on hardness, compression set which is a critical requirement in cushion/sleeping products like mattress. The particular composition is used as per requirement of properties desired in the end product.

The present disclosure gives the recipe/composition comprising of A-B-A type thermoplastic elastomer (A represents a crystalline polymer such as monoalkenylarene polymer like a polystyrene, B being elastomeric polymer like polyethylene, polybutylene) or a SEEPS, Stryene-ethylene-ethylene/propylene styrene co-block polymer, a thermoplastic material, plasticizing oil and other commonly used ingredients used in rubber compounding which can be converted into desired products by any molding method such as open dye casting, compression molding or injection molding in the temperature range 150-200 degree Celsius. Mattress made from this recipe is way better than conventional mattress material available like PU foam, memory foam, spring, latex etc. Excellent tensile strength, more than 1000% elongation, adequate rigidity, longevity and instant regain of shape after removal of pressure from the object, are some of the properties which make this material altogether different compared to common elastomers and plastics and materials used in the cushioning/mattress industry.

There are various molding methods that can be used for fabrication of desired objects, namely open dye casting, compression molding and injection molding. Any method of molding can be chosen for fabrication of the articles. Open dye casting may be method of choice for low gel content articles. Probably due to low cost and reasonable speed this method is currently used for molding of medical devices for physiotherapy and comfort. Compression molding is quite a slow process and it is seldom used in commercial production. Injection molding is a preferred method for fabrication of cushioning elements with required speed as well as adequate stiffness in the product, which can only be achieved by having a compound with comparatively medium to high elastomer content and special additives like PP.

In particular application of making reasonable size cushioning material with hollow columns using all the three molding methods as mentioned above and different oil to elastomer ratios with additives a unique recipe was developed, which gave good tensile strength, elongation ranging from 1000%-2200%, adequate stiffness and excellent shape memory. The molding method ultimately chosen was injection molding on 1600 MT capacity machine which could inject up to 15 Kg compound in one shot.

The process of compounding is described in following steps;

Mixing of Ingredients—First required quantity 65% to 85% of oil was poured into heated chamber of sigma/ribbon mixer. Preferably first put the SEEPS copolymer in the range of 15% to 35% in the oil and mix it as this will ensure proper absorption of the oil into the SEEPS co-polymer then put other fillers, Polypropylene, ADC and antioxidants to the sigma/ribbon mixer. Mixer was run after each addition for few minutes till the additive appeared to be evenly dispersed in the oil. Small portions of required amount of Septon 4055 were added to running sigma mixer and the whole mass was churned for few tens of minutes till a fluffy solid mass was obtained. The process also ensures higher oil absorption of the oil to the extent of oil to the extent of 3 to 8 times of the preferred TPE like Septon 4055. Thus, mixing method of putting Septon first into oil and mixing it before mixing ant other fillers, polymers or additives. The step of mixing wherein the TPE (Septon 4055 and Septon 4077) is first adding to the oil results in a more homogenous mixture and the adsorption of oil is better.

Pelletization—The fluffy mass obtained as above was converted to 2 mm dia. and 3 mm. long cylinders using a continuous screw injector having L/D ratio of 20 or above. Temperature across the screw was kept between 120-160 C. The process recommended is to keep the temperature lower during extrusion as we do not want the ADC blowing agent to be blowing during the palletization. If the temperature is higher (like earlier inventions), the blowing agent is likely to get de-blown/burnt during the final injection molding. A cutter was deployed at the exit point of screw extruder, which operated at a set speed to give cylinders of desired length. The exit point of extruder was cooled by passage of chilled water for solidification of compound.

Injection Molding—Injection molding was done using a 1600 MT capacity machine. The temperature across the length varied between 120-190 C in six zones. The temperature increased from hopper to injection point in a pre-decided sequence. Multi-channel injection was adopted and all the delivery lines from extruder to mold were heated between 120-150° C. The mold was provided with cooling channels for rapid cooling of compound in the mold by passing chilled water, after injection. One cycle took around 1-4 minutes. There may be cooling channels across each of the inserts of the mold to have a cooling time of less than 1 minute. Also, inject the material in the mold via a hot runner system with multiple points in less than 1 min, more preferably less than 30 sec.

The injection molding step of the invention has the various advantages over the compression moulding and hand moulding. The output article from recommended process has:
a) better texture,
b) more consistency,
c) less rejection,
d) more economical,
e) less labor intensive and
f) better quality

The present invention discloses a process and recipe for making of a yieldable thermoplastic elastomer gel for cushioning material that includes a flexible, resilient, gel cushioning media having shape memory and being substantially solid and non-flowable at temperatures below 90 degree Celsius. The process as comprises preparation of compound in an appropriate form suitable for injection molding.

Extruded objects remain usable below 90 degree Celsius that is well above normal atmospheric temperatures. The tensile strength of extruded material varies between 1.2-2.5 N/mm². Elongation measured was more than 1000. Shrinkage during molding was found 1-3%. Specific gravity of molded rubber was 0.6-0.9 g/cm³ and it is possible to reduce Specific gravity to desired value by increasing the content of ADC in the beginning during preparation of the recipe. ADC is a much more economical blowing agent. Shore A hardness of the gel is between 0 and 0, more preferred gel is between 0 to 1. The shape of the cushion with buckling column helps in air circulation and pressure reduction on different body parts.

### Steps of a Process for Making Thermoplastic Elastomer-Based Gel

### EXAMPLES

The present invention is now described by way of the following non-limited examples. While preferred aspects and example configurations have been shown and described below, it is to be understood that various further modifications and additional configurations are under development which may be apparent to those skilled in the art. It is intended that examples disclosed are illustrative of the preferred nature of the disclosure and should not be interpreted as limitations on the scope of the disclosure.

### Example 1

The gel material of example 1 has thermoplastic elastomer (Septon 4055) and mineral oil (Oil Pearl 70) from APAR industries pvt. Ltd in the ratio of 1:4. The composition of gel is 17% Septon, 72% oil, 3% polypropylene, 6% filler, 1.5% ADC and small quantity of anti-oxidants and pigment.

The properties of the gel of example 1 (smart gel of present invention) is compared with the Foam 1, 2 and 3 which are normally used in mattresses. Foam 1, 2 and 3 are conventional foams having different densities.

TABLE 1

| | | Foam 1 | Foam 2 | Foam 3 |
|---|---|---|---|---|
| | Example 1 | (Comparative | (Comparative | (Comparative |
| Properties Tested | (1: 4 with PP) | Example-1) | Example-2) | Example-3) |
| Tensile Strength | 18 | 1.25 | 1.22 | 1.19 |
| Elongation | No break (>1000%) | 159% | 142% | 152% |
| Compression Set | 0.2% | 3% | 2% | 3% |
| Post Shear Fatigue | 3% | 22% | 11.44% | 3.86% |
| Loss in Hardness | | | | |

In comparison to other materials used in mattresses, the smart gel of present disclosure has performed better across parameters of tensile strength, elongation and compression set. Also, when tested post shear fatigue (as per IS 7888), there was no loss or change in hardness. This is critical as the product needs to perform over 7-10 years and not cause sagging and deformation which is common in other materials like foam, spring etc. Also, the addition of PP helps in improving hardness and compression set.

### Example 2

The gel material of example 2 has thermoplastic elastomer (Septon 4055) and mineral oil (Oil Pearl 70) from APAR industries Pvt. Ltd, in the ratio of 1:5. The composition of the gel is 17% Septon, 76% Oil, 7% filler and small quantity of anti-oxidants and pigment.

The properties of the gel of example 2 (smart gel of present invention) is compared with Foam 1, 2 and 3 which are normally used in mattresses.

TABLE 2

| | | Foam 1 | Foam 2 | Foam 3 |
|---|---|---|---|---|
| | Example 2 | (Comparative | (Comparative | (Comparative |
| 1: 2.5 (no PP) | (1:5 with PP) | Example-1) | Example-2) | Example-3) |
| Tensile Strength | 12 | 1.25 | 1.22 | 1.19 |
| Elongation | No break (>1000%) | 159% | 142% | 152% |
| Compression Set | 0.10% | 3% | 2% | 3% |
| Post Shear Fatigue | 10% | 22% | 11.44% | 3.86% |
| Loss in Hardness | | | | |

In comparison to other materials used in mattresses, the smart gel of present disclosure has performed better across parameters of tensile strength, elongation and compression set. Also, when tested post shear fatigue (as per IS 7888), there was no loss or change in hardness. This is critical as the product needs to perform over 7-12 years and not cause sagging and deformation which is common in other materials like foam, spring etc. This recipe as in earlier inventions did not have any polypropylene and had higher percentage of Septon 4055. In spite of this it is seen worse off results on loss in hardness and compression set compared to the recipe or composition of the present disclosure. Also, the addition of PP helps in improving hardness and compression set.

### Example 3

The gel material composition of example 3 comprises Septon 4055, 17%, CaCO3: 7%, PP 320: 3%, Oil: 71%, Azodicarbonamide (ADC): 1.5%. The gel material of example 3 is compared with the gel material without having the ADC (Comparative Example-4). The properties of both the gels are shown below in table 3.

TABLE 3

| | | | | Comparative |
|---|---|---|---|---|
| | | Composition | Example 3 | Example-4 |
| | | Septon 4055 | 17% | 17% |
| | | CaCO3 | 7%, | 8%, |
| | | PP 320 | 3%, | 3%, |
| | | Oil | 71%, | 72%, |
| | | ADC | 1.5% | 0% |
| Properties | Unit | Standard | | |
| Shore A | | ASTM D2240 | 0 | 0 |
| Tensile | Kg/cm2 | ASTM D 412 | 1.2 | 0.9 |
| Elongation | % | ASTM D 412 | >1150 | 884 |
| Specific gravity | | ASTM D 792 | 0.81 | 0.89 |
| Compression set after 50% | | | | |
| compression | % Variation | IS 7888-1976 | 3.74% | 15.33% |

It can be seen from the table 3 that ADC helps in reducing specific gravity of the product and hence reduction in cost. It gives better properties like elongation and compression set. The better compression set leads to less sagging of cushioning products over time which is a critical performance parameter for cushioning objects. Also, addition of 1.5% of ADC helps in 10% weight and cost reduction.

### Example 4

The gel material composition of example 4 comprises Septon 4055: 16%-19%, CaCO3: 5%-8%, polypropylene: 3%, mineral oil: 70%-75% and ADC varied as 1.5%, 1% and 0%. The Comparative Examples 5(a), 5 (b) and 5(c) of the gel material composition without polypropylene. The properties of these gel materials are tabulated below in table 4.

TABLE 4

| | | | | Comparative | Comparative | Comparative |
|---|---|---|---|---|---|---|
| | | Composition | Example-4 | Example 5 (a) | Example 5 (b) | Example 5 (c) |
| | | Septon 4055 | 17% | 17% | 17% | 17% |
| | | CaCO₃ | 7% | 6% | 8%, | 7% |
| | | PP320 | 3% | 3% | 3% | 0% |
| | | Oil ( | 71% | 71% | 72% | 76% |
| | | ADC | 1.5% | 1% | 0% | 0% |
| Properties | Unit | Standard | | | | |
| Shore A | | ASTM D2240 | 0 | 0 | 0 | 0 |
| Tensile | Kg/cm² | ASTM D412 | 1.2 | 1 | 0.9 | 0.6 |
| Elongation | % | ASTM D412 | >1150 | >1000 | 884 | 1000 |
| Specific gravity | | ASTM D792 | 0.81 | 0.87 | 0.89 | 0.87 |
| Compression | % | IS 7888-1976 | 3.74% | 4.72% | 15.33% | 10% |
| set after 50% | variation | | | | | |
| compression | | | | | | |

| | | | |
|---|---|---|---|
| Oil Bleed | Paper Test | less oil bleed (material does not | very sticky |
| | | stick) (please review comment) | material |

It can be seen from table 4 that addition of polypropylene and more preferably impact copolymers with higher MFI helps almost no oil bleed i.e. non-sticky material and better compression. This helps in reducing cushioning sagging over time and increasing tensile strength. On the other hand, gel material without polypropylene is very sticky material having less tensile strength and more compression set after 50% compression.

Also, through experiments it has been found that thermoplastic elastomers (TPE) content of 15%-35% is suitable for obtaining desired set of properties such as tensile strength, elongation, specific gravity. The optimum levels of thermoplastic elastomers (TPE) for Septon 4077 is 15%-20% and Septon 4055 is 20% to 35% of total composition.

Areas of application: The disclosed invention can have application is cushion, mattresses, medical devices for physiotherapy, operation theatre and ICU implement, toys and shoe accessories.

### Advantages of the Invention

The gel material disclosed in the present invention provides:
good strength and stiffness;
low cost;
better physical and pressure relieving properties;
better tensile strength, elongation and compression set (evaluation of sagging over time).

1. An elastomer-based gel material comprising:
15-35 wt % of a thermoplastic elastomer,
65-85 wt % of a mineral oil,
1-10 wt % of a polypropylene, and
0.5-4 wt % of azodicarbonamide.

2. The elastomer-based gel material as claimed in claim 1, wherein the thermoplastic elastomer is A-B-A type thermoplastic elastomer.

3. The elastomer-based gel material as claimed in claim 1, wherein A represents a crystalline polymer such as alkenylarene polymer and B represents elastomeric polymer such as polyolefins.

4. The elastomer-based gel material as claimed in claim 1, wherein the alkenylarene polymer is polystyrene.

5. The elastomer-based gel material as claimed in claim 1, wherein the thermoplastic elastomer is styrene-[ethylene-(ethylene-propylene)]-styrene block copolymer.

6. The elastomer-based gel material as claimed in claim 1, wherein the polyolefins is polyethylene, polypropylene or polybutylene or combination thereof.

7. The elastomer-based gel material as claimed in claim 1, wherein the polypropylene is a homopolymer polypropylene and/or copolymer propylene.

8. The elastomer-based gel material as claimed in claim 1, wherein the gel material additionally comprises filler in the range of 1-10 wt % and antioxidant in the range of 0.05-0.5 wt %.

9. The elastomer-based gel material as claimed in claim 3, wherein the fillers are selected from the group consisting of precipitated silica, china clay and/or calcium carbonate.

10. The elastomer-based gel composition as claimed in claim 1, wherein the gel material is a cushioning material.

11. A method of producing the thermoplastic elastomer-based gel material, the method comprising:
mixing ingredients (a), (b) and (c) in a mixer to produce a powder, wherein:
(a) 65% to 85% of mineral oil;
(b) 15% to 35% of thermoplastic elastomer; and
(c) fillers, azodicarbonamide and antioxidants.
pelletizing the powder in an extruder at a temperature of 120-160° C., to produce pellets, and
injection molding the pellets at a temperature in the range of between 120-190° C. to produce the thermoplastic elastomer-based gel material.

12. The method as claimed in claim 11, wherein the mixing comprises:
pouring mineral oil into a heated chamber of a sigma/ribbon mixer;
adding thermoplastic elastomer in the oil and mixed till absorption of the oil into the elastomer; and
adding fillers, azodicarbonamide, ADC and antioxidants.

13. A cushioning material comprising the thermoplastic elastomer-based gel material as claimed in claim 1.

14. The cushioning material as claimed in claim 13, wherein the structure of the cushioning material is a buckling mold structure having homogeneously distributed hollow columns.

15. The cushioning material as claimed in claim 14, wherein the buckling mold structure has a male component having multiple designs of core, cavity or complimentary component of mold design.

16. A mattress, bed mat, sofa or chair comprising the elastomer-based gel material as claimed in claim 1.

17. The elastomer-based gel material as claimed in claim 9, wherein the fillers are selected from the group consisting of clay, calcium carbonate (CaCO₃) and silica.

18. The elastomer-based gel material as claimed in claim 9, wherein the filler is CaCO₃.
